(19) United States
(12) Patent Application Publication
(10) Pub. No.: US 2010/0023990 A1
(43) Pub. Date: Jan. 28, 2010

(54) APPARATUS AND METHOD FOR SENSING A SIGNAL USING CYCLOSTATIONARITY

(76) Inventors: Hou-shin Chen, Piscataway, NJ (US); Wen Gao, West Windsor, NJ (US)

Correspondence Address: Robert D. Shedd, Patent Operations;THOMSON Licensing LLC, P.O. Box 5312, Princeton, NJ, 08543-5312, US

(21) Appl. No.: 12/449,959

(22) PCT Filed: Jun. 20, 2007
(86) PCT No.: PCT/US2007/014577

§ 371 Date: Sep. 4, 2009

Related U.S. Application Data
(60) Provisional application No. 60/905,691, filed on Mar. 8, 2007.
(60) Provisional application No. 60/919,807, filed on Mar. 23, 2007.
(60) Provisional application No. 60/927,815, filed on May 4, 2007.

(51) Int. Cl. H04N 7/173

(52) U.S. Cl. 725/118

(57) ABSTRACT

A Wireless Regional Area Network (WRAN) receiver comprises a transceiver for communicating with a wireless network over one of a number of channels, and an Advanced Television Systems Committee (ATSC) signal detector for use in forming a supported channel list comprising those ones of the number of channels upon which an ATSC signal was not detected. The ATSC signal detector computes at least one cyclostationary feature of a received signal for determining if the received signal is an incumbent ATSC broadcast signal.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

A Wireless Regional Area Network (WRAN) system is being studied in the IEEE 802.22 standard group. The WRAN system is intended to make use of unused television (TV) broadcast channels in the TV spectrum, on a non-interfering basis, to address, as a primary objective, rural and remote areas and low population density underserved markets with performance levels similar to those of broadband access technologies serving urban and suburban areas. In addition, the WRAN system may also be able to scale to serve denser population areas where spectrum is available. Since one goal of the WRAN system is not to interfere with TV broadcasts, a critical procedure is to robustly and accurately sense the licensed TV signals that exist in the area served by the WRAN (the WRAN area).

In the United States, the TV spectrum currently comprises ATSC (Advanced Television Systems Committee) broadcast signals that co-exist with NTSC (National Television Systems Committee) broadcast signals. The ATSC broadcast signals are also referred to as digital TV (DTV) signals. Currently, NTSC transmission will cease in 2009 and, at that time, the TV spectrum will comprise only ATSC broadcast signals.

Since, as noted above, one goal of the WRAN system is to not interfere with those TV signals that exist in a particular WRAN area, it is important in a WRAN system to be able to detect ATSC broadcasts. One known method to detect an ATSC signal is to look for a small pilot signal that is a part of the ATSC signal. Such a detector is simple and includes a phase lock-loop with a very narrow bandwidth filter for extracting the ATSC pilot signal. In a WRAN system, this method provides an easy way to check if a broadcast channel is currently in use by simply checking if the ATSC detector provides an extracted ATSC pilot signal. Unfortunately, this method may not be accurate, especially in a very low signal-to-noise ratio (SNR) environment. In fact, false detection of an ATSC signal may occur if there is an interfering signal present in the band that has a spectral component in the pilot carrier position.

### SUMMARY OF THE INVENTION

We have observed that if an incumbent broadcast signal has cyclostationary properties, then these cyclostationary properties can be used by a detector to perform signal, or spectrum, sensing in a very low signal-to-noise ratio (SNR) environment. Therefore, and in accordance with the principles of the invention, an apparatus comprises a transceiver for communicating with a wireless network over one of a number of channels, and a detector for detecting an incumbent signal on one of the channels, wherein the detection is performed as a function of at least one periodic property of the incumbent signal.

In an illustrative embodiment of the invention, the transceiver is a Wireless Regional Area Network (WRAN) transceiver, and the signal detector computes at least one cyclostationary feature of a received signal for determining if the received signal is an incumbent ATSC broadcast signal. Illustratively, the cyclostationary feature is the symbol rate of the signal or the carrier frequency of the signal.

In view of the above, and as will be apparent from reading the detailed description, other embodiments and features are also possible and fall within the principles of the invention.

### BRIEF DESCRIPTION OF THE DRAWINGS

FIG. 1 shows Table One, which lists television (TV) channels;

FIGS. 2 and 3 show a format for an ATSC DTV signal;

FIG. 4 shows a prior art ATSC field sync detector;

FIG. 5 illustrates a signal model for use in understanding the inventive concept;

FIG. 6 shows an illustrative WRAN system in accordance with the principles of the invention;

FIG. 7 shows an illustrative flow chart in accordance with the principles of the invention for use in the WRAN system of FIG. 6;

FIG. 8 shows another illustrative flow chart in accordance with the principles of the invention; and

FIG. 9 shows an illustrative signal detector in accordance with the principles of the invention.

### DETAILED DESCRIPTION

Other than the inventive concept, the elements shown in the figures are well known and will not be described in detail. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternating Lines), SECAM (SEquential Couleur Avec Memoire), ATSC (Advanced Television Systems Committee), and networking, such as IEEE 802.16, 802.11h, etc., is assumed. Further information on ATSC broadcast signals can be found in the following ATSC standards: Digital Television Standard (A/53), Revision C, including Amendment No. 1 and Corrigendum No. 1, Doc. A/53C; and Recommended Practice: Guide to the Use of the ATSC Digital Television Standard (A/54). Likewise, other than the inventive concept, transmission concepts such as eight-level vestigial sideband (8-VSB), Quadrature Amplitude Modulation (QAM), orthogonal frequency division multiplexing (OFDM) or coded OFDM (COFDM)), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

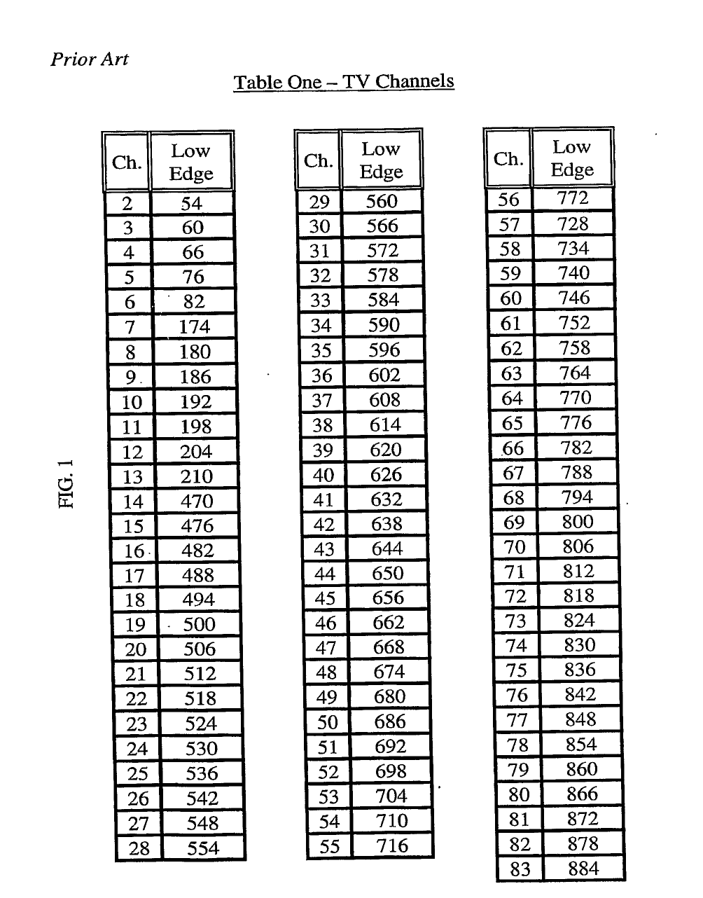

A TV spectrum for the United States is shown in Table One of FIG. 1, which provides a list of TV channels in the very high frequency (VHF) and ultra high frequency (UHF) bands. For each TV channel, the corresponding low edge of the assigned frequency band is shown. For example, TV channel 2 starts at 54 MHz (millions of hertz), TV channel 37 starts at 608 MHz and TV channel 68 starts at 794 MHz, etc. As known in the art, each TV channel, or band, occupies 6 MHz of bandwidth. As such, TV channel 2 covers the frequency spectrum (or range) 54 MHz to 60 MHz, TV channel 37 covers the band from 608 MHz to 614 MHz and TV channel 68 covers the band from 794 MHz to 800 MHz, etc. In the context of this description, a TV broadcast signal is a “wideband” signal. As noted earlier, a WRAN system makes use of unused television (TV) broadcast channels in the TV spectrum. In this regard, the WRAN system performs “channel sensing” to determine which of these TV channels are actually active (or “incumbent”) in the WRAN area in order to determine that portion of the TV spectrum that is actually available for use by the WRAN system.

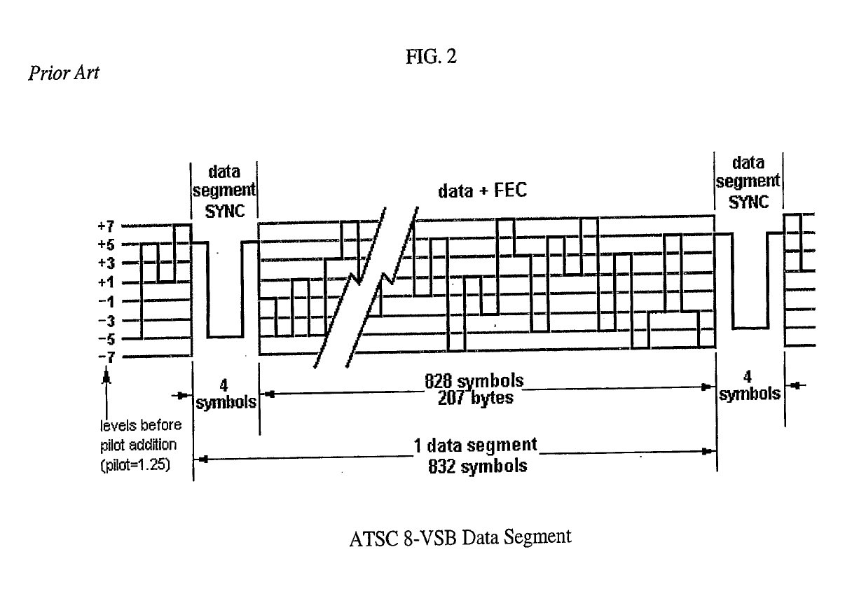

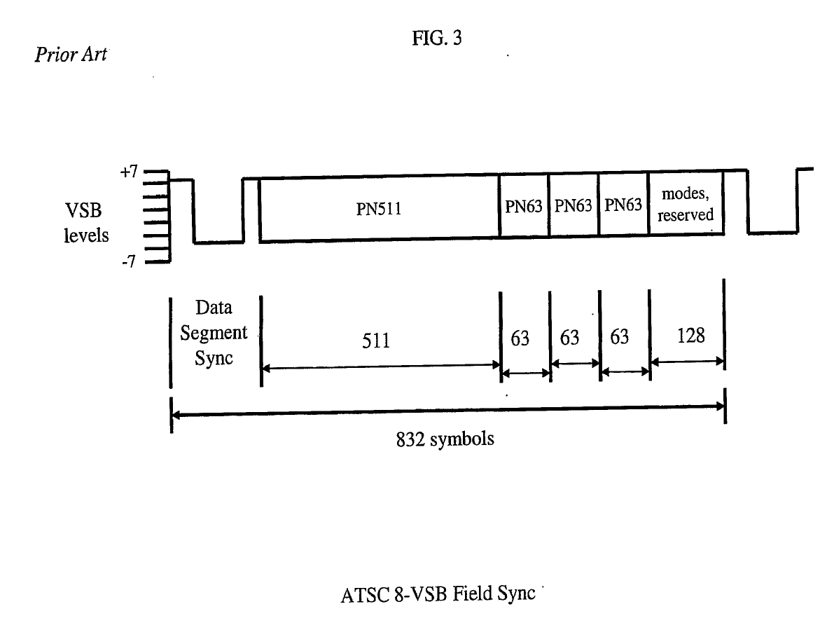

In this example, it is assumed that each TV channel is associated with a corresponding ATSC broadcast signal. The ATSC broadcast signal is also referred to herein as a digital TV (DTV) signal. The format of an ATSC signal is shown in FIGS. 2 and 3. DTV data is modulated using 8-VSB (vestigial sideband) and transmitted in data segments. An ATSC data segment is shown in FIG. 2. The ATSC data segment consists of 832 symbols: four symbols for data segment sync, and 828 data symbols. As can be observed from FIG. 2, the data segment sync is inserted at the beginning of each data segment and is a two-level (binary) four-symbol sequence representing the binary 1001 pattern, which corresponds to [5 −5 −5 5] in terms of 8-VSB symbol. Multiple data segments (313 segments) comprise an ATSC data field, which comprises a total of 260,416 symbols (832×313). The first data segment in a data field is called the field sync segment. The structure of the field sync segment is shown in FIG. 3, where each symbol represents one bit of data (two-level). In the field sync segment, a pseudo-random sequence of 511 bits (PN511) immediately follows the data segment sync. After the PN511 sequence, there are three identical pseudo-random sequences of 63 bits (PN63) concatenated together, with the second PN63 sequence being inverted every other data field.

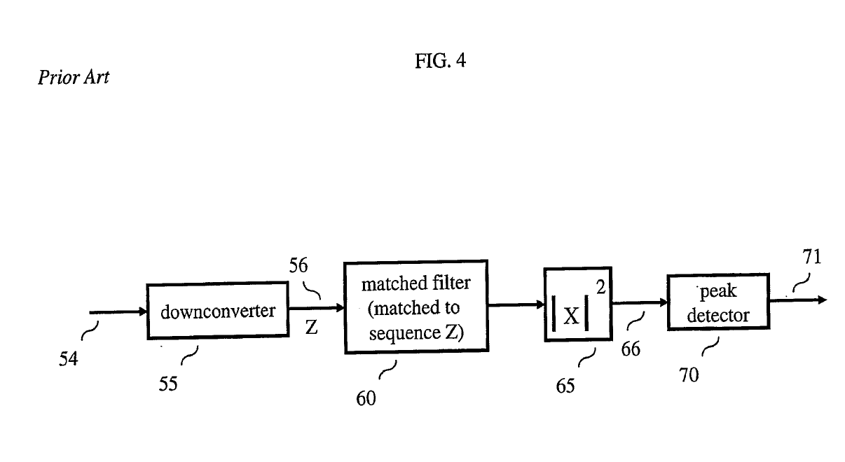

The data segment sync and field sync are representative of signature signals for an ATSC broadcast signal. For example, detection of the data segment sync pattern in a received signal can be used to identify the received signal as an ATSC broadcast signal. As such, in order to improve the accuracy of detecting ATSC broadcast signals in very low signal-to-noise ratio (SNR) environments, data segment sync symbols and field sync symbols embedded within an ATSC DTV signal can be utilized to improve the detection probability, while reducing the false alarm probability. FIG. 4 shows a prior art field sync detector. The field sync detector of FIG. 4 comprises a downconverter 55, a matched filter 60, element 65 and peak detector 70. Downconverter 55 down converts a received signal 54 to baseband in the analog or digital domain (the signal exists as digital samples, for example, at the nominal symbol rate of 10.762 MHz or at two times the symbol rate). The resulting baseband signal, 56, is applied to matched filter 60. The latter is matched to a binary sequence, i.e., the above-mentioned PN511 or PN511 plus PN63 for identifying if the received signal is an ATSC broadcast signal. For example, denote Y0 as the four symbol segment sync sequence, Y1 as the PN511 sequence, Y2 as the PN63 sequence, and Y3 as a sequence with 63 zero valued symbols. Then, denote the sequence Z=[Y0, Y1, Y2, Y3, Y2] as representing the concatenation of these sequences. The reason that Y3 (all zero sequence) is used is because the middle PN63 sequence is inverted every other field. Obviously, other forms of sequence Z can also be used to detect an ATSC DTV signal, such as Z=[Y0, Y1], Z=[Y0, Y1, Y2] or Z=[Y0, Y1, Y3, Y3, Y2], etc. Thus, the matched 60 is a filter matched to the binary sequence Z, i.e., the impulse response of the filter is [z(n), z(n−1), . . . , Z(1)] if Z is denoted as [z(1), z(2), . . . , z(n)]. It should be noted that if the sampling rate is twice the symbol rate, the Z sequence will be modified as [z(1), 0, z(2),0, z(3), . . . , 0, z(n)] where zero-valued symbols are inserted between the symbols in the Z sequence. Following the matched filter 60, the magnitude (65) of the signal is taken (or more easily, the magnitude squared is taken as I²+Q², where I and Q are in-phase and quadrature components, respectively, of the signal out of the matched filter 60). This magnitude value (66) is applied to peak detector 70, which determines if an outstanding peak exists. If an outstanding peak exists, then it is assumed that an ATSC broadcast signal is present and peak detector 70 indicates the presence of an ATSC broadcast signal via signal 71.

In contrast to the above-described signature-based detector approach, we have observed that if an incumbent broadcast signal has cyclostationary properties, then these cyclostationary properties can be used by a detector to further improve detector performance in a very low signal-to-noise ratio (SNR) environment. Therefore, and in accordance with the principles of the invention, an apparatus comprises a transceiver for communicating with a wireless network over one of a number of channels, and a detector for detecting an incumbent signal on one of the channels, wherein the detection is performed as a function of at least one periodic property of the incumbent signal.

Before describing the inventive concept, some mathematics about cyclostationarity are reviewed (also, see, e.g., G. K. Yeung and W. A. Gardner “Search-Efficient Methods of Detection of Cyclostationary Signals,” IEEE Transactions on Signal Processing, Vol. 44, No. 5, May 1996). The cyclic autocorrelation of a complex-valued time series x(t) is defined by:

$${R}_{x}^{α} ( τ ) = {lim}_{T -> ∞} \frac{1}{T} {\int }_{- T / 2}^{T / 2} x ( t + τ / 2 ) {x}^{*} ( t - τ / 2 ) {e}^{- j 2 π α t} d t , \qquad ( 1 )$$

which can be interpreted as the Fourier coefficient of any additive sine wave component with frequency α that might be contained in the delay product of x(t). Rₓ^{α}(τ) is also referred to as the cyclic autocorrelation function for a given harmonic, or cyclic frequency α. The spectral correlation function which is also known as the cyclic spectrum, can be obtained by Fourier transforming the cyclic autocorrelation of equation (1). In particular, the cyclic spectrum of x(t) for a given cyclic frequency α is:

$${S}_{x}^{α} ( f ) = F \{ {R}_{x}^{α} ( τ ) \} = {\int }_{- ∞}^{∞} {R}_{x}^{α} ( τ ) {e}^{- j 2 π f τ} d τ . \qquad ( 2 )$$

This is referred to as the cyclic Wiener relation (e.g., see W. A. Gardner, Statistical Spectral Analysis: A nonprobabilistic Theory. Englewood Cliffs, N.J.: Prentice-Hall, 1987). In the degenerate case of α=0, the left term of equations (1) and (2) become the conventional autocorrelation function and power spectral density, respectively. The measurement of equations (1) and (2) in signal analysis constitutes what is referred to as cyclic spectral analysis. A comprehensive theoretical treatment of this subject is available in W. A. Gardner, “Measurement of Spectral Correlation,” IEEE Transactions on Acoustics, Speech, and Signal Processing, Vol. ASSP-34, No. 5, October 1986. In order to compute the cyclic autocorrelation, the time-variant finite-average cyclic autocorrelation of x(t) is defined as:

$${{R}_{x}^{α} ( t , τ )}_{Δ t} = \{ \begin{matrix}\frac{1}{Δ t} {\int }_{- Δ t / 2}^{+ Δ t / 2} x ( u + τ / 2 ) {x}^{*} ( u - τ / 2 ) {e}^{- j 2 π α u } d u , & \vert τ \vert \leq Δ t \\ 0 , & \vert τ \vert > Δ t .\end{matrix} \qquad ( 3 )$$

For most useful signal and noise models, equation (3) yields a reliable estimate of the cyclic autocorrelation given in equation (1) for a sufficiently long integration time Δt, i.e.,:

$${lim}_{Δ t -> ∞} {{R}_{x}^{α} ( t , τ )}_{Δ t} = {R}_{x}^{α} ( τ ) \qquad ( 4 )$$

Thus, as a pointwise limit (in t and τ), equation (4) is simply a definition of equation (1). There are two commonly used methods to compute cyclic spectrum and they are equal in the limit sense. It can be shown that the cyclic spectrum is obtainable from the operations described by the following expression:

$${S}_{x}^{α} ( f ) = {lim}_{Δ f -> 0} {lim}_{Δ t - ∞} \frac{1}{Δ t} {\int }_{- Δ t / 2}^{Δ t / 2} Δ f {X}_{1 / Δ f} ( t , f + α / 2 ) {X}_{1 / Δ f}^{*} ( t , f - α / 2 ) d t \qquad ( 5 )$$

where X_{1/Δf}(t,v) is the complex envelope of the narrow-band-pass component of x(t) with center frequency v and approximate bandwidth Δf. This is sometimes called the short-time Fourier transform, i.e.,

$${X}_{1 / Δ f} ( t , v ) = {\int }_{- 1 / 2 Δ f}^{t + 1 / 2 Δ f } x ( u ) {e}^{- j 2 π v u} d u . \qquad ( 6 )$$

It can also be shown that Sₓ^{α}(f) is given by the limit of spectrally smoothed products of spectral components, i.e.,:

$${S}_{x}^{α} ( f ) = {lim}_{Δ f -> 0} {lim}_{Δ t -> ∞} \frac{1}{Δ f} {\int }_{f - Δ f / 2}^{f + Δ f / 2} \frac{1}{Δ t } {X}_{Δ t } ( t , v + α / 2 ) {X}_{Δ t}^{*} ( t , v - α / 2 ) d v \qquad ( 7 )$$

where X_{Δt}(t,f) is defined by equation (6) with 1/Δf replaced by Δt. Digital implementations of equations (5) and (7) are based on the use of an FFT algorithm for computing a discrete-time counterpart or a discrete-frequency counterpart of the sliding-window complex Fourier transform of equation (6). With regard to the discrete-frequency counterpart, the discrete-frequency smoothing method is given by

$$\begin{matrix}{{\tilde{S}}_{x Δ t}^{α} ( t , f )}_{Δ f} = \frac{1}{M} {\sum }_{v = - ( M - 1 ) / 2}^{( M - 1 ) / 2} \frac{1}{Δ t} {\tilde{X}}_{Δ t} ( t , f + α + {vF}_{s} ) {\tilde{X}}_{Δ t}^{*} ( t , f - α + {vF}_{s} ) \\ where & ( 8 ) \\ {\tilde{X}}_{Δ t} ( t , f ) = {\sum }_{k = 0}^{N - 1} x ( t - {kT}_{s} ) {e}^{- j 2 π f ( t - {kT}_{s} )} . & ( 9 )\end{matrix}$$

Equation (9) represents the downconverted output of a sliding Discrete Fourier Transform (DFT); where Δf=MFₛ is the width of the spectral smoothing interval; Fₛ=1/NTₛ is the frequency sampling increment; Tₛ is the time-sampling increment; and N is the number of time samples in the data segment Δt, where Δt=(N−1)Ts.

With regard to the discrete-time counterpart, the discrete-time average method is given by

$${{\tilde{S}}_{x 1 / Δ f}^{α} ( t , f )}_{Δ t} = \frac{1}{KM} {\sum }_{u = 0}^{KM - 1} Δ f {\tilde{X}}_{1 / Δ f} ( \begin{matrix}t - u / K Δ f , \\ f + α\end{matrix} ) {\tilde{X}}_{1 / Δ f}^{*} ( \begin{matrix}t - u / K Δ f , \\ f - α\end{matrix} ) \qquad ( 10 )$$

where, again, \tilde{X}_{1/Δf}(t, f) is the downconverted output of a sliding DFT; and where Δt=([1+M−1/K]N−1)Tₛ is the length of the total data segment; Δf=1(N−1)Tₛ is the spectral resolution; and N is the number of the time samples in each of the data segment of length 1/Δf.

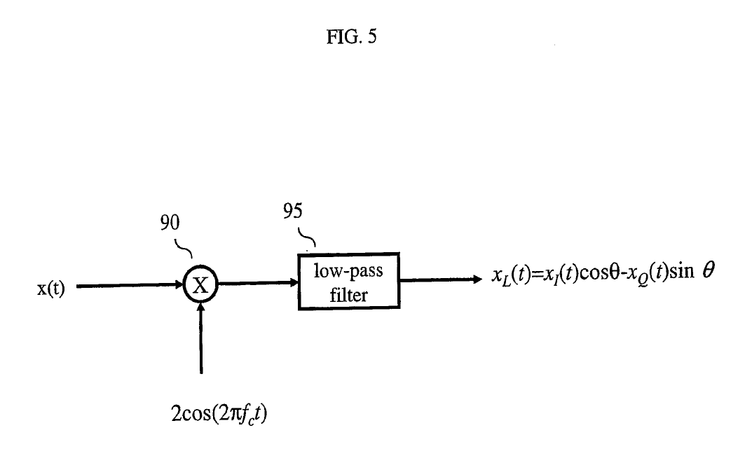

Referring now to FIG. 5, this figure illustrates a signal model for deriving the in-phase component of a band-pass signal x(t). The band-pass signal, x(t) is applied to multiplier 90, which multiplies x(t) by 2 cos(2πf_{c}t). The resulting output signal is applied to low-pass filter 95, which filters the signal from multiplier 90 and provides an output signal x_{L}(t). However, due to the phase offset, θ, the output of low-pass filter 95 includes both in-phase and quadrature phase components, i.e.,

x_{L}(t)=x₁(t)cos θ−x_{Q}(t)sin θ. (11)

In accordance with the principles of the invention, the cyclic spectrum at α=1/T₀ can be utilized to do spectrum sensing.

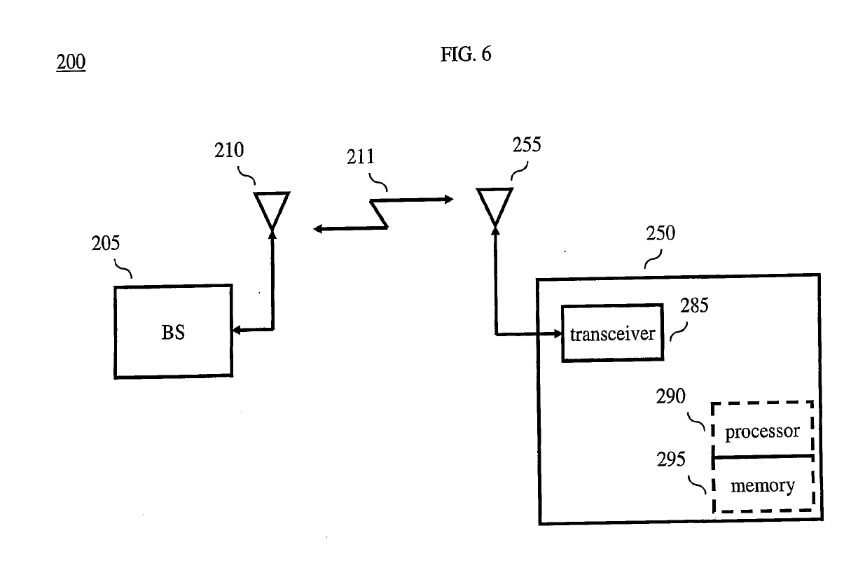

Referring now to FIG. 6, an illustrative Wireless Regional Area Network (WRAN) system 200 incorporating the principles of the invention is shown. WRAN system 200 serves a geographical area (the WRAN area) (not shown in FIG. 6). In general terms, a WRAN system comprises at least one base station (BS) 205 that communicates with one, or more, customer premise equipment (CPE) 250. The latter may be stationary. Both CPE 250 and BS 205 are representative of wireless endpoints. CPE 250 is a processor-based system and includes one, or more, processors and associated memory as represented by processor 290 and memory 295 shown in the form of dashed boxes in FIG. 6. In this context, computer programs, or software, are stored in memory 295 for execution by processor 290. The latter is representative of one, or more, stored-program control processors and these do not have to be dedicated to the transceiver function, e.g., processor 290 may also control other functions of CPE 250. Memory 295 is representative of any storage device, e.g., random-access memory (RAM), read-only memory (ROM), etc.; may be internal and/or external to CPE 250; and is volatile and/or non-volatile as necessary. The physical layer of communication between BS 205 and CPE 250, via antennas 210 and 255, is illustratively OFDM-based via transceiver 285 and is represented by arrows 211. To enter a WRAN network, CPE 250 first attempts to “associate” with BS 205. During this attempt, CPE 250 transmits information, via transceiver 285, on the capability of CPE 250 to BS 205 via a control channel (not shown). The reported capability includes, e.g., minimum and maximum transmission power, and a supported, or available, channel list for transmission and receiving. In this regard, CPE 250 performs “channel sensing” in accordance with the principles of the invention to determine which TV channels are not active in the WRAN area. The resulting available channel list for use in WRAN communications is then provided to BS 205. The latter uses the above-described reported information to decide whether to allow CPE 250 to associate with BS 205.

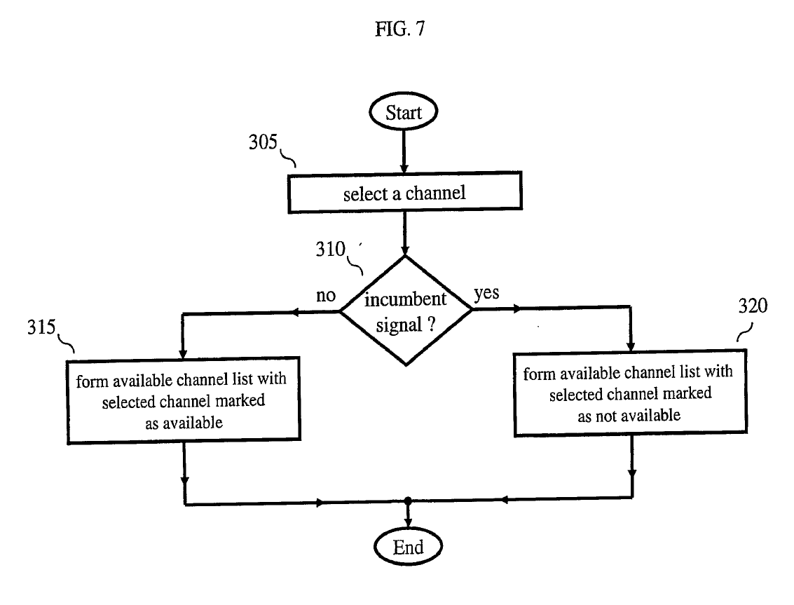

Turning now to FIG. 7, an illustrative flow chart for use in performing channel sensing in accordance with the principles of the invention is shown. The flow chart of FIG. 7 can be performed by CPE 250 over all of the channels, or only over those channels that CPE 250 has selected for possible use. Preferably, in order to detect incumbent signals in a channel, CPE 250 should cease transmission in that channel during the detection period. In this regard, BS 205 may schedule a quiet interval by sending a control message (not shown) to CPE 250. In step 305, CPE 250 selects a channel. In this example, the channel is assumed to be one of the TV channels shown in Table One of FIG. 1 but the inventive concept is not so limited and applies to other channels having other bandwidths. In step 310, CPE 250 scans the selected channel to check for the existence of an incumbent signal. In particular, CPE 250 computes at least one cyclostationary feature of a received signal for determining if the received signal is an incumbent ATSC broadcast signal (described further below). If no incumbent signal has been detected, then, in step 315, CPE 250 indicates the selected channel as available for use by the WRAN system on an available channel list (also referred to as a frequency usage map). However, if an incumbent signal is detected, then, in step 320, CPE 250 marks the selected channel as not available for use by the WRAN system. As used herein, a frequency usage map is simply a data structure stored in, e.g., memory 295 of FIG. 6, that identifies one, or more, channels, and parts thereof, as available or not for use in the WRAN system of FIG. 6. It should be noted that marking a channel as available or not can be done in any number of ways. For example, the available channel list may only list those channel that are available, thus effectively indicating other channels as not available. Similarly, the available channel list may only indicate those channels that are not available, thus effectively indicating other channels as available.

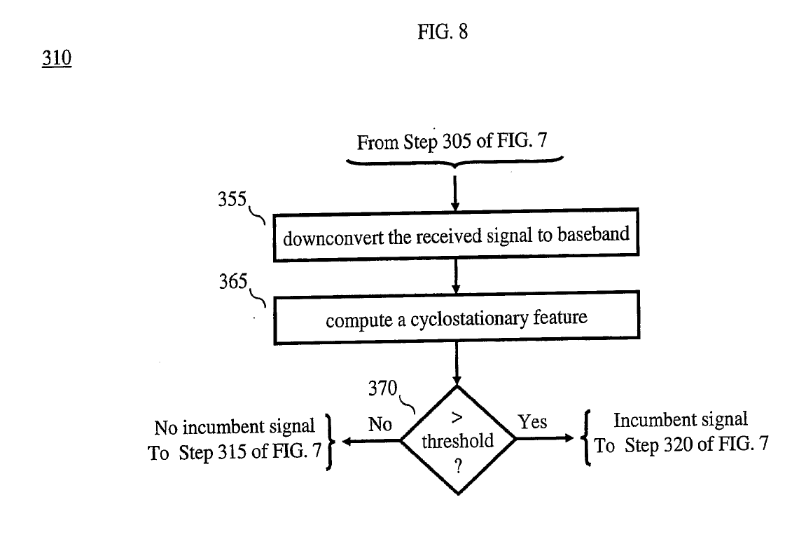

An illustrative flow chart for performing step 310 of FIG. 7 is shown in FIG. 8. In step 355, CPE 250 downconverts the signal on the selected channel to produce a signal x[n]. CPE 250 may also perform low-pass filtering of the downconverted signal for producing the signal y[n]. In step 365, CPE 250 computes at least one cyclostationary feature, T, of y[n] (described below). In step 370, CPE 250 compares the computed cyclostationary feature, T, to a threshold value, which may be determined experimentally. If the computed cyclostationary feature, T, is greater then the threshold value, then it is assumed that an ATSC broadcast signal is present. However, if the computed cyclostationary feature, T, is less than, or equal to, the threshold value, then it is assumed that an ATSC broadcast signal is not present.

As described above, in step 365 CPE 250 computes a cyclostationary feature, T, of the received signal. In this illustrative embodiment, CPE 250 is performing spectrum sensing to look for an incumbent signal that is an ATSC broadcast signal. As noted above, for an ATSC broadcast signal, the cyclic spectrum at α=1/T₀, where T₀ is the symbol rate of the ATSC signal, is utilized to do spectrum sensing. In another embodiment of this invention, the cyclic spectrum can be the carrier frequency of the ATSC signal. There are basically two ways to extract a cyclostationary feature from the received signal. One is to compute the cyclic autocorrelation function and the other is to compute the cyclic spectrum.

For extracting a cyclostationary feature by computation of the cyclic autocorrelation function, one can make use of the above-mentioned reference of W. A. Gardner, “Measurement of Spectral Correlation,” IEEE Transactions on Acoustics, Speech, and Signal Processing, Vol. ASSP-34, No. 5, October 1986, i.e.,

$${R}_{y}^{α} ( t , τ ) = \frac{1}{Δ t} {\int }_{t - Δ t / 2}^{t + Δ t / 2} x ( u + τ / 2 ) {x}^{*} ( u - τ / 2 ) {e}^{- j 2 π α u} d u , \\ \vert τ \vert \leq Δ t \qquad ( 12 )$$

In order to obtain more samples of R_{y}^{1/T}^{₀}(t,τ) in the τ axis, it may be necessary to perform interpolation on y[n]. It should be noted that there may be other ways to compute the cyclic autocorrelation function (not described herein). With respect to equation (12), since the cyclic spectrum at α=1/T₀ is utilized to perform spectrum sensing, it can be supposed that the cyclic autocorrelation sequence is in the cyclic frequency 1/T₀−δ≦α≦1/T₀+δ (α is discrete in this range), and that these are denoted as {\hat{R}_{y}^{α}[n]}ₙ₌₀^{L-1}, where

\hat{R}_{y}^{α}[n]=R_{y}^{α}(t,τ)|_{τ=nT}_{ₛ}

and Tₛ is the sampling interval. It should also be noted that if a frequency offset exists that it may be necessary to compute the cyclic spectrum in several cyclic frequencies around α=1/T₀.

With respect to determining the cyclostationary feature, T, from the cyclic autocorrelation function, the following are some illustrative examples of decision statistics that can be used in step 365 of FIG. 8:

$$1. T = {max}_{α} {max}_{0 \leq n \leq L - 1} \vert {\hat{R}}_{y}^{α} [ n ] \vert$$

which is the maximum absolute value of the sequence {\hat{R}_{y}^{α}[n]}ₙ₌₀^{L-1}.

$$2. T = {max}_{α} {max}_{i} {\sum }_{n = 0}^{W - 1} \vert {\hat{R}}_{y}^{α} [ n + i ] \vert$$

which is the maximum sum of the absolute value of the sequence {\hat{R}_{y}^{α}[n]}ₙ₌₀^{L-1} over a window having length W.

$$3. T = {max}_{α} \vert E ( {\hat{R}}_{y}^{α} [ n ] ) \vert$$

which is the maximum mean of the cyclic autocorrelation sequence over cyclic frequency α.

$$4. T = {max}_{α} Var ( {\hat{R}}_{y}^{α} [ n ] )$$

which is the maximum variance of the cyclic autocorrelation sequence over cyclic frequency α. As described above, once a value for T is determined in step 365 of FIG. 8, the resulting value for T is compared against a threshold value (step 370 of FIG. 8) for determining if an incumbent signal is present in the selected channel.

Turning now to the extraction of a cyclostationary feature by computation of the cyclic spectrum, either equation (8) or equation (10) can be used for this computation (rewritten below as equation (13) and equation (15), below):

$$\begin{matrix}{{\tilde{S}}_{y Δ t}^{1 / {T}_{0}} ( t , f )}_{Δ f} = \\ \frac{1}{M} {\sum }_{v = - ( M - 1 ) / 2}^{( M - 1 ) / 2} \frac{1}{Δ t} {\tilde{Y}}_{Δ t} ( t , f + 1 / 2 {T}_{0} + {vF}_{s} ) {\tilde{Y}}_{Δ t}^{*} ( t , f - 1 / 2 {T}_{0} + {vF}_{s} ) & ( 13 ) \\ where \\ {\tilde{Y}}_{Δ t} ( t , f ) = {\sum }_{n = 0}^{N - 1} y ( t - {nT}_{s} ) {e}^{- j 2 π f ( t - {nT}_{s} )} & ( 14 ) \\ {{\tilde{S}}_{y 1 / Δ f}^{1 / {T}_{0}} ( t , f )}_{Δ t} = \frac{1}{KM} {\sum }_{u = 0}^{KM - 1} Δ f {\tilde{Y}}_{1 / Δ f} ( t - u / K Δ f , f + 1 / 2 {T}_{0} ) \\ {\tilde{Y}}_{1 / Δ f}^{*} ( t - u / K Δ f , f - 1 / 2 {T}_{0} ) & ( 15 )\end{matrix}$$

It should be noted that there may be other ways to compute the cyclic spectrum (not described herein). As before, since the cyclic spectrum at α=1/T₀ is utilized to do spectrum sensing and it may be necessary to compute the cyclic spectrum in several cyclic frequencies around α=1/T₀, it can be supposed that there are discrete samples of the cyclic spectrum {Ŝ_{y}^{α}[m]}ₘ₌₀^{N-1}, where

Ŝ_{y}^{α}[m]=\tilde{S}_{yl/Δf}^{α}(t,f)_{Δt}|_{f=mF}_{ₛ}

and 1/T₀−δ≦α≦1/T₀+δ (α is discrete in this range).

With respect to determining the cyclostationary feature, T, from computation of the cyclic spectrum, similar decision statistics to those described above can be used in step 365 of FIG. 8, i.e.,:

$$1. T = {max}_{α} {max}_{0 \leq m \leq N - 1} \vert {\hat{S}}_{y}^{α} [ m ] \vert$$

$$2. T = {max}_{α} {max}_{i} {\sum }_{m = 0}^{W - 1} \vert {\hat{S}}_{y}^{α} [ m + i ] \vert$$

$$3. T = {max}_{α} \vert E ( {\hat{S}}_{y}^{α} [ m ] ) \vert$$

$$4. T = {max}_{α} Var ( {\hat{S}}_{y}^{α} [ m ] )$$

As described earlier, once a value for T is determined in step 365 of FIG. 8, the resulting value for T is compared against a threshold value (step 370 of FIG. 8) for determining if an incumbent signal is present in the selected channel.

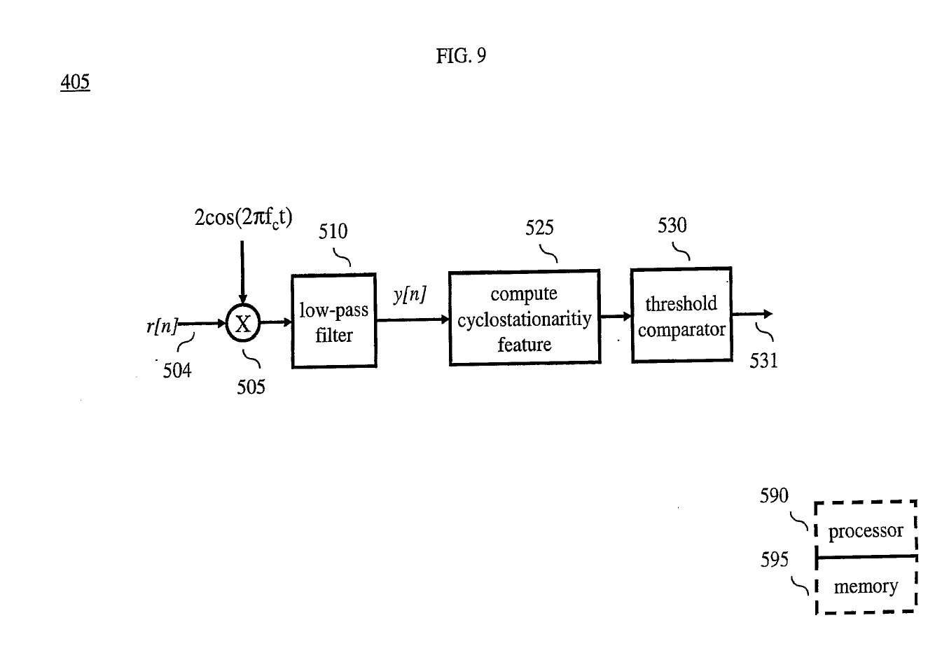

Turning briefly to FIG. 9, an illustrative portion of a receiver 405 for use in CPE 250 is shown (e.g., as a part of transceiver 285). Only that portion of receiver 405 relevant to the inventive concept is shown. The elements shown in FIG. 9 generally correspond to the description of the steps for the flow chart of FIG. 8. As such, the elements shown in FIG. 9 can be implemented in hardware, software, or as a combination of hardware and software. In this regard, receiver 405 is a processor-based system and includes one, or more, processors and associated memory as represented by processor 590 and memory 595 shown in the form of dashed boxes in FIG. 9. It should be noted that processor 590 and memory 595 may be in addition to, or the same as, processor 290 and memory 295 of FIG. 6. Receiver 405 comprises multiplier 505, low pass filter 510, element 525 for computing at least one cyclostationary feature and threshold comparator 530. For simplicity, some elements are not shown in FIG. 9, such as an automatic gain control (AGC) element, an analog-to-digital converter (ADC) if the processing is in the digital domain, and additional filtering. Other than the inventive concept, these elements would be readily apparent to one skilled in the art. Further, those skilled in the art would recognize that some of the processing may involve complex signal paths as necessary.

In the context of the above-described flow charts, for each selected channel a received signal 504 may be present. Multiplier 505 downconverts the received signal, r[n], where the carrier frequency, f_{c}, is selected as a function of the currently selected channel (e.g., see FIG. 1). The downconverted signal is low pass filtered by low pass filter 510 to produce base-band signal y[n]. Element 525 computes at least one cyclostationary feature, T, for y[n], as described above. Threshold comparator 530 compares the value for T against a threshold value to determine if an incumbent signal is present and provides the results via signal 531.

As described above, it is possible to detect the presence of ATSC DTV signals in low signal-to-noise environments with high confidence using cyclostationary properties of the incumbent signal. However, the inventive concept is not so limited and can also be applied to detecting any signal that has cyclostationary properties. For example, the inventive concept is applicable to detection of OFDM type signals, e.g., such as used in DVB-T (Digital Video Broadcasting-Terrestrial). Further, the inventive concept can be combined with other techniques for detecting the presence of a signal, e.g., energy detection, etc. It should also be noted that although the inventive concept was described in the context of CPE 250 of FIG. 6, the invention is not so limited and also applies to, e.g., a receiver of BS 205 that may perform channel sensing. Further, the inventive concept is not restricted to a WRAN system and may be applied to any receiver that performs channel, or spectrum, sensing.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements (e.g., of FIG. 9) may be implemented in a stored-program-controlled processor, e.g., a digital signal processor, which executes associated software, e.g., corresponding to one, or more, of the steps shown in, e.g., FIGS. 7 and 8. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in a wireless endpoint, the method comprising:
selecting one of a number of channels; and
determining a cyclostationary feature of a signal on the selected channel from at least one periodic property representative of an incumbent signal for detecting the presence of the incumbent signal on the selected channel.

2. The method of claim 1, wherein the periodic property is a symbol rate of the incumbent signal.

3. The method of claim 2, wherein the incumbent signal is an Advanced Television Systems Committed (ATSC) signal.

4. The method of claim 1, wherein the periodic property is a carrier frequency of the incumbent signal.

5. The method of claim 1, wherein the determining step comprises the steps of:
downconverting the signal to a baseband signal;
determining a cyclostationary feature of the baseband signal; and
comparing the determined cyclostationary feature to a threshold value for detecting the presence of the incumbent signal on the selected channel.

6. The method of claim 5, wherein the downconverting step comprises the steps of:
downconverting the signal to a downconverted signal; and
low pass filtering the downconverted signal for providing the baseband signal.

7. The method of claim 1, wherein the determining step comprises the step of:
determining the cyclostationary feature by computation of an cyclic autocorrelation function.

8. The method of claim 7, wherein the cyclostationary feature is represented by a parameter T, where
$$T = {max}_{α} {max}_{0 \leq n \leq L - 1} \vert {\hat{R}}_{y}^{α} [ n ] \vert .$$

9. The method of claim 7, wherein the cyclostationary feature is represented by a parameter T, where
$$T = {max}_{α} {max}_{i} {\sum }_{n = 0}^{W - 1} \vert {\hat{R}}_{y}^{α} [ n + i ] \vert .$$

10. The method of claim 7, wherein the cyclostationary feature is represented by a parameter T, where
$$T = {max}_{α} \vert E ( {\hat{R}}_{y}^{α} [ n ] ) \vert .$$

11. The method of claim 7, wherein the cyclostationary feature is represented by a parameter T, where
$$T = {max}_{α} Var ( {\hat{R}}_{y}^{α} [ n ] ) .$$

12. The method of claim 1, wherein the determining step comprises the step of:
determining the cyclostationary feature by computation of a cyclic spectrum.

13. The method of claim 12, wherein the cyclostationary feature is represented by a parameter T, where
$$T = {max}_{α} {max}_{0 \leq m \leq N - 1} \vert {\hat{S}}_{y}^{α} [ m ] \vert .$$

14. The method of claim 12, wherein the cyclostationary feature is represented by a parameter T, where
$$T = {max}_{α} {max}_{0 \leq m \leq N - 1} \vert {\hat{S}}_{y}^{α} [ m ] \vert .$$

15. The method of claim 12, wherein the cyclostationary feature is represented by a parameter T, where
$$T = {max}_{α} \vert E ( {\hat{S}}_{y}^{α} [ m ] ) \vert .$$

16. The method of claim 12, wherein the cyclostationary feature is represented by a parameter T, where
$$T = {max}_{α} Var ( {\hat{S}}_{y}^{α} [ m ] ) .$$

17. The method of claim 1, further comprising the step of:
marking an available channel list to indicate that the selected channel is available for use if no incumbent signal is present.

18. Apparatus comprising:
a downconverter for providing a baseband signal from a selected channel; and
a processor for use in determining a cyclostationary feature of the baseband signal from at least one periodic property representative of an incumbent signal for detecting the presence of the incumbent signal on the selected channel.

19. The apparatus of claim 18, wherein the periodic property is a symbol rate of the incumbent signal.

20. The apparatus of claim 19, wherein the incumbent signal is an Advanced Television Systems Committed (ATSC) signal.

21. The apparatus of claim 18, wherein the periodic property is a carrier frequency of the incumbent signal.

22. The apparatus of claim 18, further comprising:
a low pass filter coupled to the downconverter, wherein the low pass filter provides the baseband signal;
wherein the processor determines the cyclostationary feature from the baseband signal, and compares the determined cyclostationary feature to a threshold value for detecting the presence of the incumbent signal on the selected channel.

23. The apparatus of claim 18, wherein the processor determines the cyclostationary feature by computation of an cyclic autocorrelation function.

24. The apparatus of claim 18, wherein the processor determines the cyclostationary feature by computation of a cyclic spectrum.

25. The apparatus of claim 18, further comprising:
a memory for storing an available channel list to indicate that the selected channel is available for use if no incumbent signal is present.
